(19) United States
(12) Patent Application Publication
(10) Pub. No.: US 2013/0080532 A1
(43) Pub. Date: Mar. 28, 2013

(54) SYSTEM AND METHOD FOR PROVIDING A POSTMORTEM SOCIAL FAREWELL

(71) Applicant: David D. Stewart, Farmington, MN (US)

(72) Inventor: David D. Stewart, Farmington, MN (US)

(21) Appl. No.: 13/631,218

(22) Filed: Sep. 28, 2012

Related U.S. Application Data
(63) Continuation of application No. 61/626,544, filed on Sep. 28, 2011.

(51) Int. Cl. G06F 15/16

(52) U.S. Cl. 709/204

(57) ABSTRACT

A system and method for providing a postmortem social farewell having a computer implemented method of providing a postmortem social farewell from a social network user having a social network account, the method including establishing a postmortem account for the social network user, the postmortem account including postmortem subscriber information, login data for the social network account, and social farewell content; and comparing the postmortem subscriber information to death information on a trusted death index. When the postmortem subscriber information matches the death information, the method continues with accessing the social network account using the login data; and posting the social farewell content on the social network account.

### CROSS-REFERENCE TO RELATED APPLICATIONS

The present application claims the benefit of U.S. Provisional Patent Application Ser. No. 61/626,544 filed Sep. 28, 2011, the complete subject matter of which is incorporated herein by reference in its entirety.

### TECHNICAL FIELD

The technical field of this disclosure is social networking, particularly, systems and methods for providing a postmortem social farewell.

### BACKGROUND OF THE INVENTION

Online social networking sites such as Facebook.com, Google+.com, Twitter.com, LinkedIn.com, and MySpace.com have become very popular for posting thoughts, ideas, and videos. The definition of a “friend” or someone that is close to one in society has changed through the use of these social networking sites. A friend is no longer just someone you see socially or speak to on the telephone. With this broader definition of friends, the question arises as to how to contact the social networking friends in the event of one's demise. An additional question arises as to how an individual's intellectual property on the social networking site is to be used.

Existing services have been established which allow a subscriber to post a message or video after their demise. Unfortunately, the way in which existing services determine the death of a subscriber is subject to error at best or cruel hoaxes at worst. For instance, ifidie.net has the subscriber choose three people to notify ifidie.net when the system subscriber has passed: what happens if they pass prior to you passing? What happens if the three people pull a prank causing the leak of private information? All existing services relying on the outside world for confirmation of the subscriber's death and to update social networking accounts.

It would be desirable to have a system and method for providing a postmortem social farewell that would overcome the above disadvantages.

### SUMMARY OF THE INVENTION

One aspect of the present invention provides a computer implemented method of providing a postmortem social farewell from a social network user having a social network account, the method including establishing a postmortem account for the social network user, the postmortem account including postmortem subscriber information, login data for the social network account, and social farewell content; and comparing the postmortem subscriber information to death information on a trusted death index. When the postmortem subscriber information matches the death information, the method continues with accessing the social network account using the login data; and posting the social farewell content on the social network account.

Another aspect of the present invention provides a system for providing a postmortem social farewell from a social network user having a social network account, the system including a processor and a memory coupled to the processor. The memory contains programming code to establish a postmortem account for the social network user, the postmortem account including postmortem subscriber information, login data for the social network account, and social farewell content; and compare the postmortem subscriber information to death information on a trusted death index. The memory further contains programming code to, when the postmortem subscriber information matches the death information, access the social network account using the login data; and post the social farewell content on the social network account.

Another aspect of the present invention provides a computer program product for providing a postmortem social farewell from a social network user having a social network account, the computer program product including a computer-readable storage medium containing computer program code for establishing a postmortem account for the social network user, the postmortem account including postmortem subscriber information, login data for the social network account, and social farewell content; and comparing the postmortem subscriber information to death information on a trusted death index. The computer-readable storage medium further contains computer program code for, when the postmortem subscriber information matches the death information, accessing the social network account using the login data; and posting the social farewell content on the social network account.

This system and method relates to the integration of Social Networking and the posting of final words or videos (a Social Farewell) in their Social Networks in the event of an individual's death. This gives the individual control over their final Social Farewell as long as the information stored in file for this process is up to date and correct. This system and method creates an opportunity for individuals to store their Social Networking login data, and final posts, videos, or combinations of posts and videos in a postmortem account that includes social farewell content to be posted to the individual's requested sites upon the notification/confirmation of their death. The final posts, videos, or combinations of posts and videos can be called a Social Farewell made up of social farewell content.

This system and method searches death indexes to confirm whether account holders are dead or alive. The processes are based on verifiable information to confirm the account holder's status and a process that is strictly between the account holder and the system site. Examples of death indexes include the Social Security Death Index (SSD I) and other verifiable sources, including those of other countries.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a block diagram of a system for providing a postmortem social farewell in accordance with the present invention.

FIG. 2 is a flowchart of a method for providing a postmortem social farewell in accordance with the present invention.

FIG. 3 is a detailed flowchart of a method for providing a postmortem social farewell in accordance with the present invention.

### DETAILED DESCRIPTION OF PRESENTLY PREFERRED EMBODIMENTS

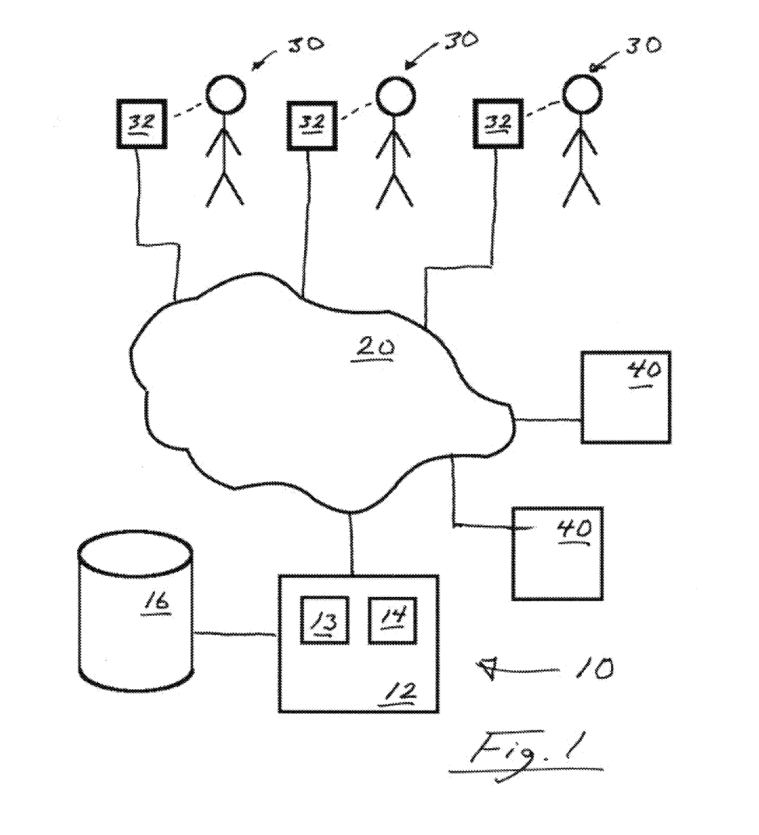

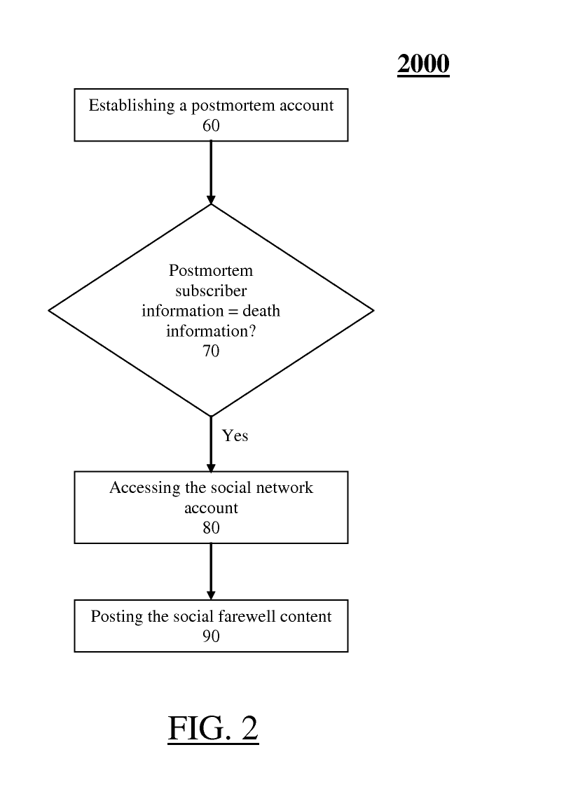

FIG. 1 is a block diagram of a system for providing a postmortem social farewell in accordance with the present invention. The system 10 can be used to perform the methods described in conjunction with FIGS. 2 & 3.

Referring to FIG. 1, the system 10 includes one or more servers 12 having a processor 13 and memory 14 coupled to the processor. The memory 14 can contain programming code. The system 10 can also include optional storage 16 as a computer-readable storage medium, which can contain a database of publicly provided death certificates, computer instructions, programming code, computer program code, and other information as desired. The system 10 is operably connected to the World Wide Web/Internet 20. The system 10 is accessible to users 30 through access devices 32 and the World Wide Web/Internet 20. Exemplary access devices 30 to include Web-enabled personal computers (PCs), personal digital assistants (PDAs), cell phones, and the like. Each user 30 can also access other users 30 and one or more social network site 40 over the access devices 32 and the World Wide Web/Internet 20. Exemplary social network sites 40 include Facebook.com, Google+.com, Twitter.com, LinkedIn.com, MySpace.com, and the like. The users 30 can have a social network account on one or more of the social network site 40 and can post content to their social network account. The users 30 can also view content posted by other users 30 on the social network site 40. Those skilled in the art will appreciate that the system 10 components, such as the servers 12 and the optional database storage 16, can be any number of centralized and/or distributed components as desired for a particular application.

FIG. 2 is a flowchart of a method for providing a postmortem social farewell in accordance with the present invention. The method 2000 is a computer implemented method of providing a postmortem social farewell from a social network user having a social network account. The method 2000 includes establishing a postmortem account 60 for the social network user, the postmortem account including postmortem subscriber information, login data for the social network account, and social farewell content; and comparing the postmortem subscriber information to death information 70 on a trusted death index. When the postmortem subscriber information matches the death information, the method continues with accessing the social network account 80 using the login data; and posting the social farewell content 90 on the social network account. When the postmortem subscriber information does not match the death information, the method 2000 can repeat the comparison of the postmortem subscriber information with the death information periodically, such as daily, weekly, monthly, or the like, see if the status of the social network user has changed.

The establishing a postmortem account 60 allows the social network user to plan a postmortem social farewell to take place on his demise. The social network user can be a user at any social network, such as Facebook.com, Google+.com, Twitter.com, LinkedIn.com, MySpace.com, and the like.

The postmortem account can include postmortem subscriber information, login data for the social network account of the social network user, and social farewell content. The postmortem subscriber information can include any information about the social network user that would allow them to be identified, such as name, address, Social Security Number, government issued identification number, physical description, and the like. The login data for the social network account of the social network user allows the method 2000 to access the social network account on the demise of the social network user. In one embodiment, the login data is the social network password of the social network user for a social network site. In another embodiment, the login data is social network interface code that allows the provider of the postmortem account to post the social farewell content on the social network account. The social network interface code can be associated with an application programming interface (API) on the social network site, such as Facebook.com, Google+.com, Twitter.com, LinkedIn.com, MySpace.com, and the like, which allows the provider of the postmortem account to communicate with the social network site.

As defined herein, social farewell content is any content, such as message posts, video posts, and the like, that the social network user would like to have disseminated through their social network account on their demise. In one embodiment, the postmortem account can also include prewritten e-mails from the social network user, and the method 2000 can further include sending the prewritten e-mails when the postmortem subscriber information matches the death information. The prewritten e-mails can include the e-mail addresses of the intended recipients. In another embodiment, the postmortem account can also include trusted contact information for a trusted contact as discussed below.

Once the postmortem account is established, the social network user can update the postmortem account as desired. In one embodiment, the postmortem account is stored in a secure database and can also be encrypted if desired.

The method 2000 can continue with comparing the postmortem subscriber information to death information 70 on a trusted death index. In one example, the trusted death index can be a publicly available document such as published obituaries, national death indices for US or other countries, Social Security Death Indices, and the like. In another example, the trusted death index can be a public or private database of publicly provided death certificates, e.g., third parties can send death certificates for storage on the database, initiating the process of posting the social farewell content on the social network account when the third party knows that the social network user has a postmortem account. The method 2000 can optionally include comparing the postmortem subscriber information to death information on a trusted death index at a predetermined frequency, such as daily, weekly, monthly, or the like.

The method 2000 can take a number of actions when the postmortem subscriber information matches the death information. The method 2000 can continue with accessing the social network account 80 using the login data; and posting the social farewell content 90 on the social network account. Thus, the social farewell content which the social network user desired to have posted on his demise appears on his social network account. In one embodiment, the method 2000 can also include archiving and inactivating the postmortem account when the postmortem subscriber information matches the death information. This allows the social network user to tie up their affairs after his demise. In another embodiment, the method 2000 can also include establishing a memorial website online when the postmortem subscriber information matches the death information. Optionally, the method 2000 can accept subscriptions from third parties to the memorial website, allowing the third parties to view the website and post content. In one embodiment, the social network user can design their own memorial website, either designing from scratch or based on a template containing suggested text, pictures, videos, and the like.

In one embodiment, the method 2000 can also include additional safeguards to confirm that the social network user is actually dead before accessing the social network account using the login data and posting the social farewell content on the social network account. The postmortem account can include trusted contact information for a trusted contact to provide confirmation by a knowledgeable person that the social network user is deceased. The trusted contact can be any person selected by the social network user who is likely to know of his circumstances, such as friends, family, coworkers, and the like. In one example, the trusted contact can be the social network user themselves, allowing the social network user to report that the news of their death was greatly exaggerated. The trusted contact information can be any information that allows the method 2000 to get in touch with the trusted contact, such as name, address, telephone number, e-mail address, and the like.

When the postmortem subscriber information matches the death information, and before the accessing the social network account and the posting the social farewell content, the method 2000 can send a rebuttal notification request to the trusted contact using the trusted contact information. When a response to the rebuttal notification request from the trusted contact rebuts death of the social network user indicating that the social network user is still alive, the method 2000 can repeat the comparison of the postmortem subscriber information with the death information periodically to see if the status of the social network user has changed. When the response to the rebuttal notification request from the trusted contact confirms the death of the social network user, the method 2000 can proceed to accessing the social network account using the login data and posting the social farewell content on the social network account in accordance with the final wishes of the social network user.

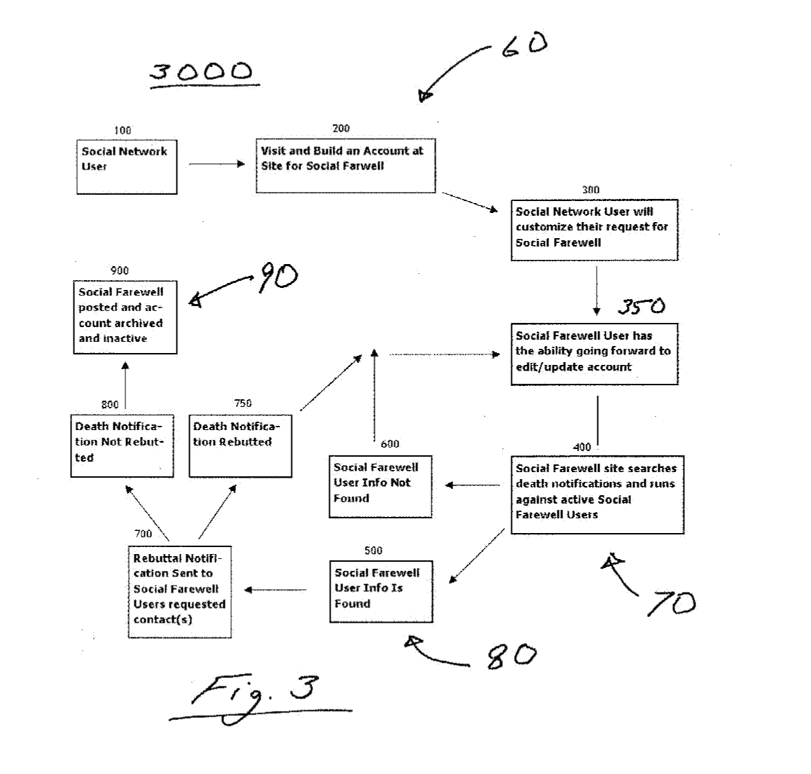

FIG. 3, in which like elements share like reference numbers with FIG. 2, is a detailed flowchart of a method for providing a postmortem social farewell in accordance with the present invention. The method 3000 includes establishing a postmortem account 60 with a social network user 100 visiting and building an account at a site for social farewell 200 and customizing the request for social farewell 300. The method 3000 optionally includes the social farewell user editing/updating their account 350. The method 3000 includes comparing the postmortem subscriber information to death information 70 by searching death notifications against information for active social farewell users 400. When social farewell user information is found 500 to indicate a match, the method 3000 can optionally include sending a rebuttal notification to the social farewell user's requested contact 700, then proceeding to post the social farewell the death notification is not rebutted 800 or return to searching death notifications 400 when the death notification is rebutted 750. The method 3000 includes accessing the social network account 80 and posting the social farewell content 90 with the social farewell being posted and, optionally, the postmortem account being archived and made inactive 900.

This system and method can be used to design a site on the World Wide Web that individuals 100 can use to design a custom and private account on 200. On this account, individuals can house their social networking log-ins and any posts/videos (Social Farewell) they'd like placed on each chosen social networking site upon their death 300. All posts will can in accordance of the social networking sites utilized. The operators of the site will on a daily, weekly, or monthly basis, as deemed most effective, use specific fields from individuals with accounts to search death notifications for individuals with accounts 400. Death notifications can include, but are not limited to, obituaries, National Death Indexes, Social Security Death Indexes, and family provided death certificates to the site. If an individual's account information is not matched in the death notification searches 600, the account will remain active and their search information included in ongoing searches. Upon matching an individual with an account on the website and one of the death notification methods 500, a previously defined notification by the individual can be sent out by the website to offer a rebuttal of the death notification that was found 700. This notification for rebuttal can be used as a safety net to avoid improperly posting an account user's Social Farewell. Upon no rebuttal 800, the individual with an account's Social Farewell 900 can be posted to the social networking sites they've desired and preset. At this point, the individual's personal information and account data can be archived and cease to be active on the site for further Death Notification searching. Upon a rebuttal of the information found in death notifications 750, the individual account can stay active on the site for continued searches of the death notifications.

Further opportunities from the site created on the World Wide Web include, but are not limited to personal custom url's/website's for the individual account holder that are to be made active upon the individual's death. Theses websites can incorporate memorial-like information for the individuals' friends and family to visit and remember the individual.

Other opportunities include remembrance reminders and support information for friends and families of the individuals. These reminders will help cope with the loss of the individual with the account. This would be an option/product that they can subscribe to after seeing or finding an individual's Social Farewell or reporting death with a death certificate to the site.

It is important to note that FIGS. 1-3 illustrate specific applications and embodiments of the present invention, and are not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A computer implemented method of providing a postmortem social farewell from a social network user having a social network account, the method comprising:
establishing a postmortem account for the social network user, the postmortem account including postmortem subscriber information, login data for the social network account, and social farewell content; and
comparing the postmortem subscriber information to death information on a trusted death index;
when the postmortem subscriber information matches the death information:
accessing the social network account using the login data; and
posting the social farewell content on the social network account.

2. The method of claim 1 further comprising repeating the comparing periodically when the postmortem subscriber information does not match the death information.

3. The method of claim 1 further comprising updating of the postmortem account by the social network user.

4. The method of claim 1 wherein the postmortem account further includes trusted contact information for a trusted contact, and the method further comprises:
when the postmortem subscriber information matches the death information, and before the accessing and the posting, sending a rebuttal notification request to the trusted contact using the trusted contact information;
when a response to the rebuttal notification request from the trusted contact rebuts death of the social network user, repeating the comparing periodically; and
when the response to the rebuttal notification request from the trusted contact confirms the death of the social network user, proceeding to the accessing and the posting.

5. The method of claim 4 wherein the trusted contact is the social network user.

6. The method of claim 1 wherein the postmortem account further includes prewritten e-mails from the social network user, the method further comprising sending the prewritten e-mails when the postmortem subscriber information matches the death information.

7. The method of claim 1 further comprising archiving and inactivating the postmortem account when the postmortem subscriber information matches the death information.

8. The method of claim 1 further comprising establishing a memorial website online when the postmortem subscriber information matches the death information.

9. The method of claim 8 further comprising accepting subscriptions from third parties to the memorial website.

10. The method of claim 1 wherein the social farewell content is selected from the group consisting of message posts and video posts.

11. The method of claim 1 wherein the postmortem account is stored in a secure database.

12. The method of claim 1 wherein the comparing comprises comparing the postmortem subscriber information to death information on a trusted death index at a predetermined frequency.

13. The method of claim 1 wherein the trusted death index is selected from the group consisting of published obituaries, national death indices, and Social Security Death Indices.

14. The method of claim 1 wherein the trusted death index comprises a database of publicly provided death certificates.

15. The method of claim 1 wherein the login data is selected from the group consisting of a social network password and social network interface code.

16. A system for providing a postmortem social farewell from a social network user having a social network account, the system comprising:
a processor and a memory coupled to the processor, the memory containing programming code to:
establish a postmortem account for the social network user, the postmortem account including postmortem subscriber information, login data for the social network account, and social farewell content; and
compare the postmortem subscriber information to death information on a trusted death index;
when the postmortem subscriber information matches the death information:
access the social network account using the login data; and
post the social farewell content on the social network account.

17. The system of claim 16 wherein the memory further contains programming code to periodically compare the postmortem subscriber information to the death information on the trusted death index when the postmortem subscriber information does not match the death information.

18. The system of claim 16 wherein the postmortem account further includes trusted contact information for a trusted contact, and the memory further contains programming code to:
when the postmortem subscriber information matches the death information, and before accessing the social network account and posting the social farewell content, send a rebuttal notification request to the trusted contact using the trusted contact information;
when a response to the rebuttal notification request from the trusted contact rebuts death of the social network user, periodically compare the postmortem subscriber information to the death information on the trusted death index; and
when the response to the rebuttal notification request from the trusted contact confirms the death of the social network user, proceed to accessing the social network account and posting the social farewell content.

19. The system of claim 16 wherein the memory further contains programming code to archive and inactivate the postmortem account when the postmortem subscriber information matches the death information.

20. The system of claim 16 wherein the memory further contains programming code to establish a memorial website when the postmortem subscriber information matches the death information.

21. A computer program product for providing a postmortem social farewell from a social network user having a social network account, the computer program product comprising a computer-readable storage medium containing computer program code for:
establishing a postmortem account for the social network user, the postmortem account including postmortem subscriber information, login data for the social network account, and social farewell content; and
comparing the postmortem subscriber information to death information on a trusted death index;
when the postmortem subscriber information matches the death information:
accessing the social network account using the login data; and
posting the social farewell content on the social network account.

22. The product of claim 21 wherein the computer-readable storage medium further contains computer program code for repeating the comparing periodically when the postmortem subscriber information does not match the death information.

23. The product of claim 21 wherein the postmortem account further includes trusted contact information for a trusted contact, and the computer-readable storage medium further contains computer program code for:
when the postmortem subscriber information matches the death information, and before the accessing and the posting, sending a rebuttal notification request to the trusted contact using the trusted contact information;
when a response to the rebuttal notification request from the trusted contact rebuts death of the social network user, repeating the comparing periodically; and
when the response to the rebuttal notification request from the trusted contact confirms the death of the social network user, proceeding to the accessing and the posting.

24. The product of claim 21 wherein the computer-readable storage medium further contains computer program code for archiving and inactivating the social network account when the postmortem subscriber information matches the death information.

25. The product of claim 21 wherein the computer-readable storage medium further contains computer program code for establishing a memorial website when the postmortem subscriber information matches the death information.
